(19) United States
(12) Patent Application Publication
(10) Pub. No.: US 2025/0083818 A1
(43) Pub. Date: Mar. 13, 2025

(54) Load Support for Water-Basted Human Airlift Operations

(71) Applicant: Vita Inclinata IP Holdings LLC, Broomfield, CO (US)

(72) Inventors: Robert C. Cockell, II, Victor, MT (US); F. Troy Coburn, Medford, OR (US)

(73) Assignee: Vita Inclinata IP Holdings LLC, Broomfield, CO (US)

(21) Appl. No.: 18/925,652

(22) Filed: Oct. 24, 2024

Related U.S. Application Data
(63) Continuation of application No. PCT/US2024/043983, filed on Aug. 27, 2024.
(60) Provisional application No. 63/537,764, filed on Sep. 11, 2023.

(51) Int. Cl. B64D 1/22; B64D 25/06; B66C 1/12

(52) U.S. Cl. CPC B64D 1/22; B64D 25/06; B66C 1/12

(57) ABSTRACT

A body-conforming pouch for water-based human airlift lift operations.

### CROSS-REFERENCE TO RELATED APPLICATIONS

The present application is a continuation of and claims priority to International Application number PCT/US2024/043983, filed 2024 Aug. 27; this application and International Application number PCT/US2024/043983 claim the benefit of U.S. Provisional patent application 63/537,764, filed 2023 Sep. 11; the benefit of the filing dates of the foregoing applications is claimed by the present application and the subject matter thereof is incorporated by this reference.

### FIELD

This application and related subject matter (collectively referred to as the “disclosure”) generally concern a load support, such as a rescue harness, and related components and methods. More particularly, but not exclusively, this disclosure pertains to a load support suitable for use with a carrier, such as a helicopter, in human airlift operations, particularly water-based human airlift operations.

### BACKGROUND INFORMATION

Helicopters and other carriers (including fixed-wing aircraft, line-systems, and cranes, hereinafter, referred to as a “carrier”) may be used to lift and transport loads. This may be referred to as “airlifting” or an “airlift operation”. Airlift operations may occur in terrain that is not accessible to or is dangerous for pedestrians, rescuees, rescuers, wheeled vehicles, boats or other motorized conveyances. For example, helicopters can be used to transport loads such as humans, equipment, water, and the like to or from areas, wherein the areas may comprise bodies of water (e.g. swamps, rivers, lakes, oceans, and the like), vegetation and the like and wherein the areas may be characterized by topography ranging from flat and regular to irregular topography comprising steep slopes, cliffs, and the like. The areas may comprise hazards to the carrier, to carrier crew, to persons on the ground, and to the loads, such as powerlines, military activity, rock falls, avalanches, waterfalls, wildlife, cold, heat, and the like. Airlift operations may further comprise a load stabilization system, wherein the load stabilization system applies a thrust vector to the load to stabilize, position, or orient the load, wherein the thrust vector may come from a thruster. The thruster may comprise, for example, a fin, drogue, guy line, fans, flywheels, gyroscopes, and the like.

Airlift operations comprising the transport of human loads are referred to herein as, “human airlifting” or “human airlift operations” or, when the human is a rescuee, “rescue airlift operations”, all of which may be referred to herein as a “human airlift operation”. A human in a human airlift operation may be referred to herein as a “human”, a “rescuee”, a “rescuer”, or as a “load”. Human airlift operations may use a harness, strop, litter, or cage (hereinafter, “load support”) to secure a load, e.g. one or more humans, to a carrier with a cable system, e.g. a suspension cable, with or without a thruster, generally below the carrier. For relatively short human airlift operations, which may be referred to as “short haul” airlifts, the load may remain below the carrier at a fixed distance. For longer flights, the load may be hoisted up towards or to the carrier, maybe secured proximate to, in, or on the carrier. During a human airlift operation, the carrier may remain relatively stationary in the air until the load is raised or may move only a relatively short distance at low speed, whereupon the load may be lowed to the ground, to minimize air flow on the load due to flight or to deliver the load to an area accessible to ground transportation or rescue services. However, this may be dangerous, for example, in military contexts where a helicopter or other carrier may be a target for an attack if it remains on the scene, in situations where time is of the essence, such as when transporting an injured human, or in remote locations where ground rescue services are remote from an initial scene.

During human airlift operations beneath a carrier, a suspension cable may be secured to a hoist within or of the carrier; the hoist may comprise an arm and a reel; the arm may extend beyond an interior of the carrier and may provide the suspension cable an unobstructed path to the ground. The reel may be actuated to extend, retract, or reel in or reel out the suspension cable and load. The arm may rotate, translate, extend or retract, e.g. such that the suspension cable and/or load can avoid a bottom feature of a carrier, such as landing gear of a helicopter, a bottom or exterior of a cockpit, or the like, as the reel is actuated, and to allow the arm, load (which may include a rescue litter or other load support), and/or hoist to be moved inside and outside of the carrier.

During human airlift operations it may be necessary or desirable to use a load support (e.g. a harness, strop, litter, cage, or the like) to secure a human to a hook or the like at a terminal end of a suspension cable and hoist.

Some human airlift operations comprise circumstances in which the human is in or proximate to a body of water; the body of water may be cold; the human may be unconscious and/or hypothermic. During such human airlift operations, a rescuer or similar party may have limited dexterity or facility to secure the human to or in the load support, e.g. due to cold, use of gloves, and numerous mental, physical, and emotional demands placed on the rescuer. During water-based human airlift operations, which often include a rescuer, the rescuer may need to transport the load support from the carrier and deploy it in the water. For example, a rescuer secured to a suspension cable beneath a carrier may pass a strop-a padded band, also referred to herein as a chest band-beneath the arms of the human to be airlifted, e.g. through the armpits of the human to be airlifted. Ends of the strop may be secured to the suspension cable and the reel of the hoist may be actuated, to draw the rescuer and human to the carrier, or the carrier may ascend in elevation. Strops are designed to present the smallest “sail area” in the water as possible to allow the rescuer to maneuver the strop beneath the arms of the rescuee and to attach the strop to the suspension cable with the fewest number of steps and in the least amount of time possible. During human airlift operations, including and during water-based human airlift operations, time is of the essence for both the rescuer and the rescuee.

For example, rescue vest 1800 in FIG. 18 requires that the rescuer maneuver the rescuee's hands and arms through two arm holes before the crotch strap could be drawn through the rescuee's legs and the two top clips and crotch strap could be secured to the suspension cable. In a water-based human airlift operation, rescue vest 1800 would present a large “sail area” in the water and its transport and deployment would be too complex and unpredictable. Due to these complexities, rescue vest 1800, leg loops, and the like (e.g. other load supports designed for land-based use) are only considered for use with respect to land-based human airlift operations and are not considered for water-based human airlift operations and are not admitted by the Applicant of the present application to be “prior art” for water-based human airlift operations (notwithstanding use of this label in the Figures, as may be required by United States patent practice and regulations). Cold, wind, waves, short mission time, condition of the rescuee and rescuer, and posture of the rescuee and rescuer in the water preclude use of rescue vest 1800 and the like in a human airlift operation in the water.

During a water-based human airlift operation in which a strop is used, if the rescuee is unconscious, hypothermic, or is otherwise not able to hold the rescuee's arms down, the strop may slide up, over the rescuee's shoulders and/or arms and the rescuee may slip through the strop. Consequently, some protocols for conducting such operations specify that the rescuer is to, if able, hold the rescuee's arms down, e.g. by wrapping the rescuer's arms or legs around the rescuee's arms. This maneuver requires that the rescuer be positioned relative to the rescuee to allow the rescuer's arms or legs to wrap around the rescuee's arms. However, due to a wide range of circumstances, the rescuer is not always able or available to perform this maneuver. Furthermore, when a strop is used in a water-based human airlift operation, the duration, distance, speed, and height of the airlift may be reduced to reduce exposure to risks and likelihood of harm to the rescuee and rescuers. Consequently, strops are often not recommended for land-based human airlift operations.

An improved strop for water-based human airlift operations is strop 1700 illustrated in FIGS. 17A and 17B, comprising crotch strap 1705 and webbing 1710 which may extend from strop 1700 through a crotch of the rescuee. Strop 1700 may comprise a pocket for one or more of crotch strap 1705 and webbing 1710, to keep these components stowed and out of the way until they are deployed. However, a water-based human airlift operation using strop 1700 may fail if the human slumps sideways and through crotch strap 1705 and webbing 1710. This may occur, for example, due to loss of consciousness, loss of muscle control, hypothermia, loss or lack of capability, and the like.

In addition, ends of a strop (with or without leg loops or a crotch strap) may be secured to a suspension cable with a hardware and or cable or strap system (“strap system”). The strap system may tighten or cinch the strop on or around a chest of the rescuee. Such strap systems may use a mass and or acceleration of the rescuee to increase a cinch force on the rescuee; however such strap systems may prevent the rescuee from breathing adequately, may impede blood flow within the rescuee, and may result in injuries to, unconsciousness of, or death of the rescuee.

Consequently, strops for water-based human airlift operations are designed to meet a variety of sometimes conflicting operational demands including reduced “sail area”, that they be rapid to deploy and easy to use, that they should hold the rescuee as securely as possible, and that they should also not harm the rescuee in use. Strops for water-based airlift operations are often not able to balance these sometimes conflicting demands.

Consequently, water-based human airlift operations involving strops may be performed only when necessary, only when other load supports are not available or practical, and may be limited in time, distance, speed, and height. Many missions are not able to meet all of these criteria. Many water-based human airlift operations involving strops have resulted in harm to the rescuee and or rescuer.

Needed is a load support for water-based human airlift operations which provides minimal sail area, that is rapid to deploy and easy to use, that holds the rescuee securely with reduced demands placed on the rescuer and rescuee (e.g. with reduced requirement that the rescuee's arms be actively held down during the operation), and with reduced likelihood that the load support will harm the rescuee.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIG. 1 illustrates a front perspective view of an embodiment of a stowable body pouch, wherein the stowable body pouch is secured to a suspension cable and contains a human.

FIG. 2 illustrates a front perspective view of the embodiment of the stowable body pouch secured to the suspension cable of FIG. 1, without the human.

FIG. 3 illustrates a first back perspective view of an embodiment of a stowable body pouch secured to a suspension cable, wherein the stowable body pouch is partially deployed.

FIG. 4 illustrates a second back perspective view of an embodiment of a stowable body pouch secured to a suspension cable, wherein the stowable body pouch is further deployed, compared to FIG. 3, though is not fully deployed.

FIG. 5 illustrates a side perspective view of an embodiment of a stowable body pouch secured to a suspension cable, wherein the stowable body pouch is further deployed, compared to FIG. 4, though is not fully deployed and wherein a crotch strap of the stowable body pouch is being secured to the suspension cable.

FIG. 6 illustrates a side perspective view of an embodiment of a stowable body pouch secured to a suspension cable, wherein the stowable body pouch is fully deployed.

FIG. 7 illustrates a first example of a pattern for textiles of a stowable body pouch, according to an embodiment.

FIG. 8 illustrates a second example of a pattern for textiles of a stowable body pouch, according to an embodiment.

FIG. 9 illustrates an oblique parallel projection view of an example of a first female connection hardware.

FIG. 10 illustrates the oblique parallel projection view of the example of the first female connection hardware of FIG. 9, further comprising a retaining spring.

FIG. 11A illustrates the oblique parallel projection view of the example of the first female connection hardware, retaining spring, and further comprising a male connection hardware.

FIG. 11B illustrates a side parallel projection view of the example of the first female connection hardware, retaining spring, and male connection hardware.

FIG. 12 illustrates the oblique parallel projection view of the example of the first female connection hardware and retaining spring of FIG. 11A, further comprising the double-sided male connection hardware of FIG. 11B.

FIG. 13 illustrates the oblique parallel projection view of the example of the first connection hardware, retaining spring, and double-sided male connection hardware of FIG. 12, further comprising a second female connection hardware.

FIG. 14 illustrates a plan view of another example of a female connection hardware, according to an embodiment.

FIG. 15 illustrates a plan view of another example of a female connection hardware, according to an embodiment.

FIG. 16A illustrates a first embodiment of a pocket for a stowable body pouch, according to an embodiment.

FIG. 16B illustrates a second embodiment of a pocket for a stowable body pouch, according to an embodiment.

FIG. 16C illustrates a third embodiment of a pocket for a stowable body pouch, according to an embodiment.

FIG. 16D illustrates a fourth embodiment of a pocket for a stowable body pouch, according to an embodiment.

FIG. 16E illustrates a fifth embodiment of a pocket for a stowable body pouch, according to an embodiment.

FIG. 16F illustrates a sixth embodiment of a pocket for a stowable body pouch, according to an embodiment.

FIG. 16DF illustrates a seventh embodiment of a pocket for a stowable body pouch, according to an embodiment.

FIG. 16G illustrates an eighth embodiment of a pocket for a stowable body pouch, according to an embodiment.

FIG. 17A illustrates a first example of prior art.

FIG. 17B illustrates the first example of prior art of FIG. 17A being fitted on a human.

FIG. 18 illustrates an example of a load support used exclusively in land-based human airlift operations, which may not be considered prior art with respect to water-based human airlift operations.

### DETAILED DESCRIPTION

The following describes various principles related to a stowable body pouch and connection hardware, suitable for use in water-based human airlift operations.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Generally, these terms are to be understood from a point of view of a first human that is looking at a front of another standing human. Such terms are not, however, intended to imply absolute relationships, positions, and/or orientations. For example, with respect to an object, an “upper” surface can become a “lower” surface simply by turning the object over. Nevertheless, it is still the same surface, and the object remains the same. As used herein, “and/or” means “and” or “or”, as well as “and” and “or.”

Elements in figures may be identified with a number; the number may be followed by a letter. When an identification number is followed by a letter, all elements with the same number are substantially similar or identical; all such elements with the same number and different letters may be referred to with the identification number, without the letter.

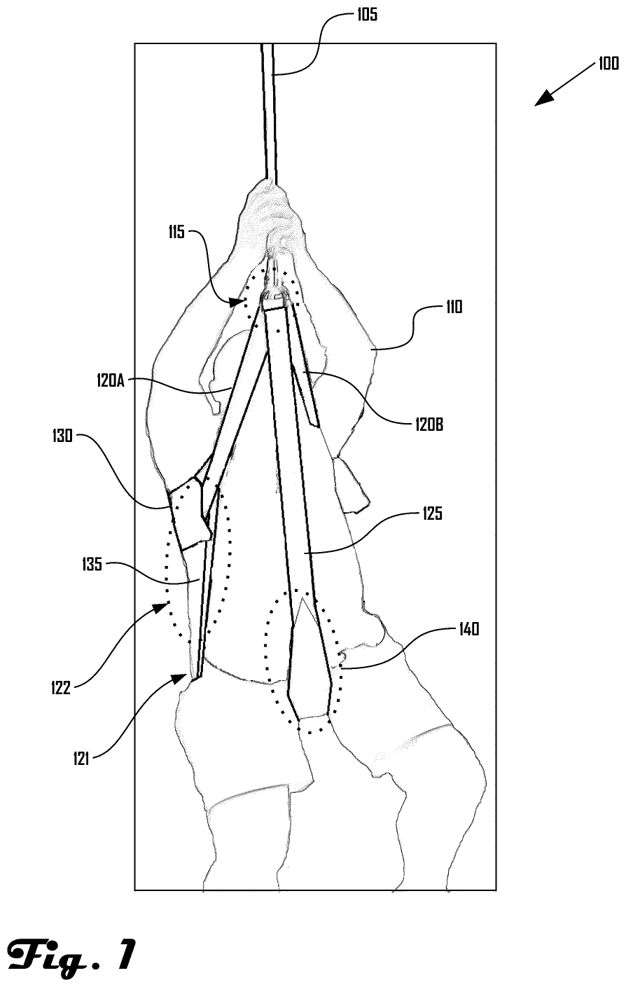

Solutions to problems of previous approaches, some of which problems are discussed above, may comprise a body pouch suitable to airlift a human from water with a carrier, the body pouch comprising an axillary band, a hip retaining portion, and a crotch portion. The axillary band may be structured so as to fit around a back, sides, and under armpits of the human and to not encircle a shoulder of the human. Please see, for example, human 110 of FIG. 1 in body pouch 100, comprising axillary band 130 (“axillary band” may be understood as “armpit band”). As illustrated in FIG. 1, human 110 is to be suspended below a carrier on suspension cable 105. Axillary band 130 passes under armpits of human 110, around sides of human 110, and around a back of human 110. Axillary band 130 comprises or is secured to a pair of top connection straps 120A and 120B. Body pouch 100 comprises side retaining portion 122, crotch portion 140, and crotch strap 140. Side retaining portion 122 comprises perimeter webbing 135. Top connection straps 120A, 120B, and crotch strap 125 connect to suspension cable 105 via connection hardware 115. In FIG. 1, hip retaining portion 121 is pointed to by number 121, though is only partially visible.

Hip retaining portion 121 and side retaining area 122 allow body pouch 100 to hold human 110, with reduced concern for whether human 110 may become unconscious and may reduce a danger that human 110 may slip out of body pouch 100 during a water-based human airlift operation, thereby contributing to addressing problems with prior art rescue strops for water-based human airlift operations discussed in the Background section, above. In addition, hip retaining portion 121, side retaining area 122, crotch portion 140, and crotch strap 125 may be stowed in a pocket of body pouch 100 prior to transportation and deployment, may be deployed, and may be secured to suspension cable 105 using connection hardware 115, thereby reducing a sail area of body pouch 100, and without placing undue demands on a rescuer or on human 110, and thereby further contributing to addressing problems with prior art rescue strops for water-based human airlift operations discussed in the Background section, above.

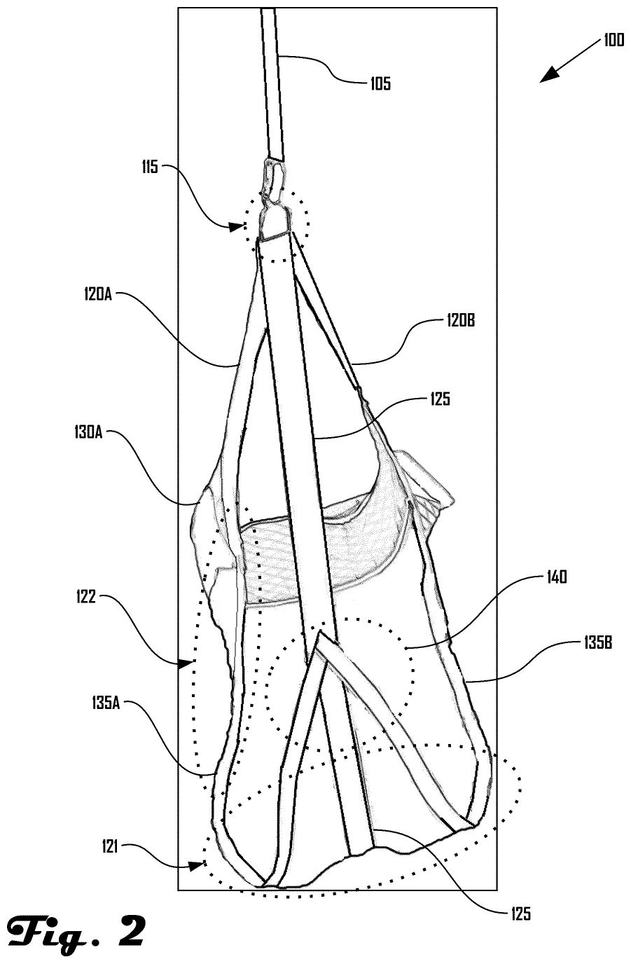

FIG. 2 illustrates body pouch 100, without human 110. FIG. 2 illustrates that perimeter webbing 135A and perimeter webbing 135B are secured to crotch strap 125 in crotch portion 140. FIG. 2 further illustrates hip retaining portion 121.

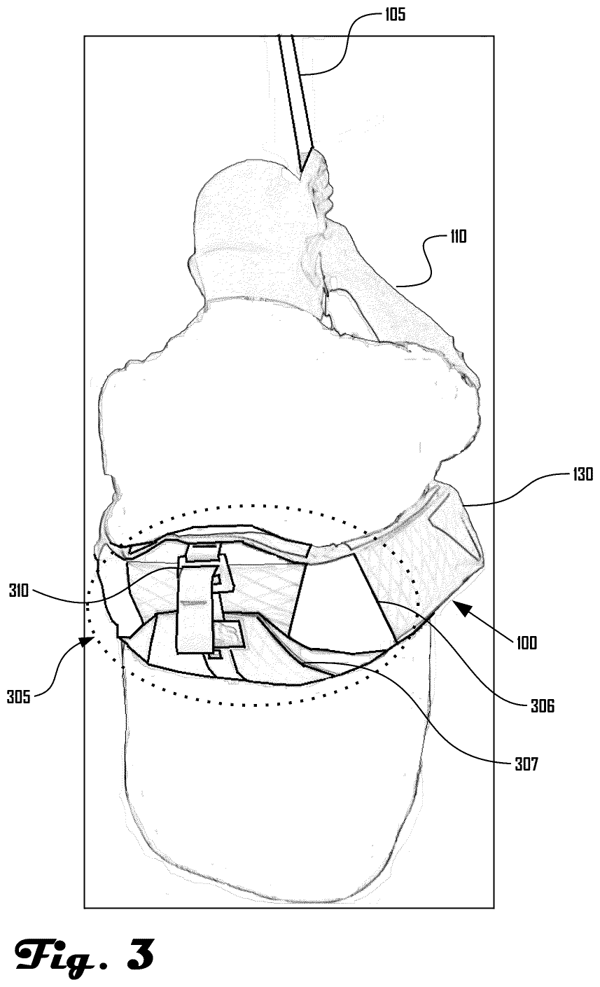

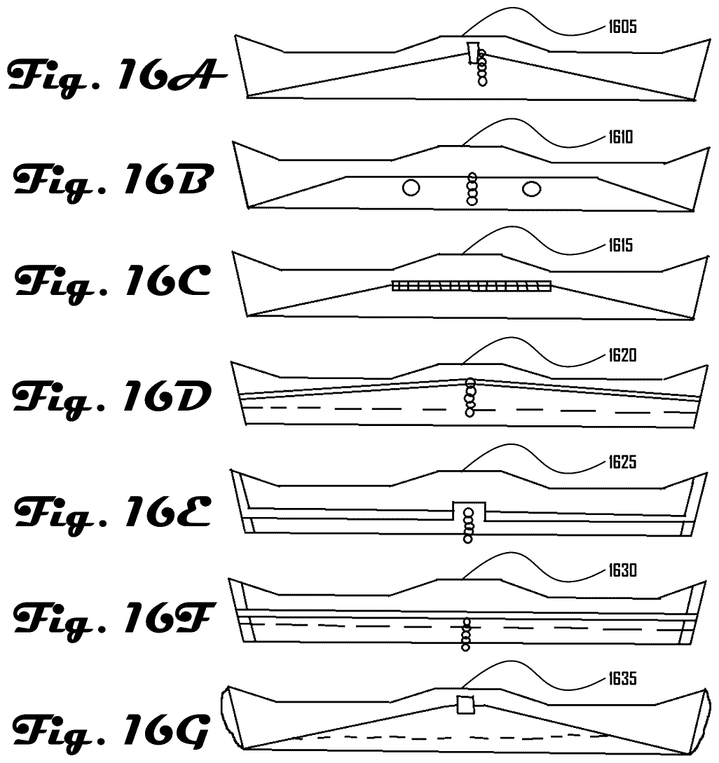

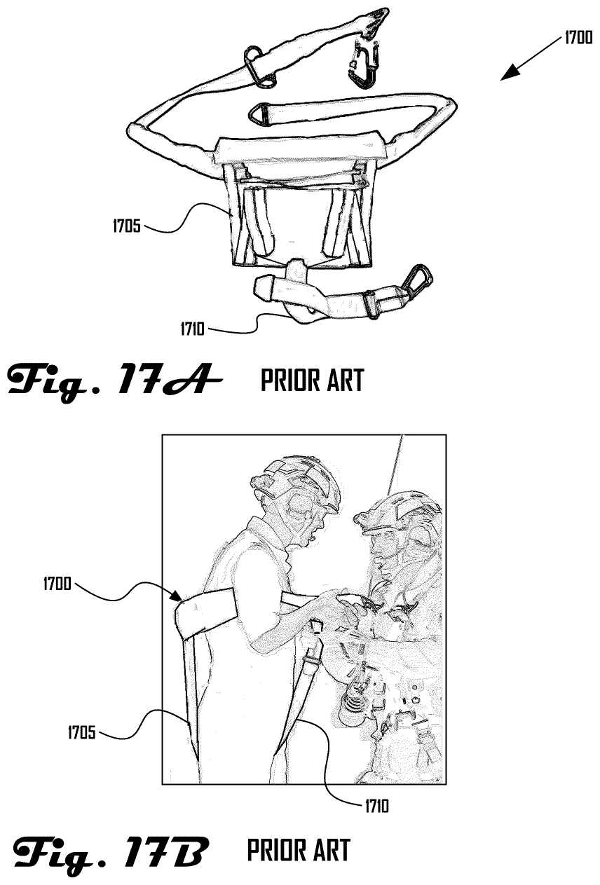

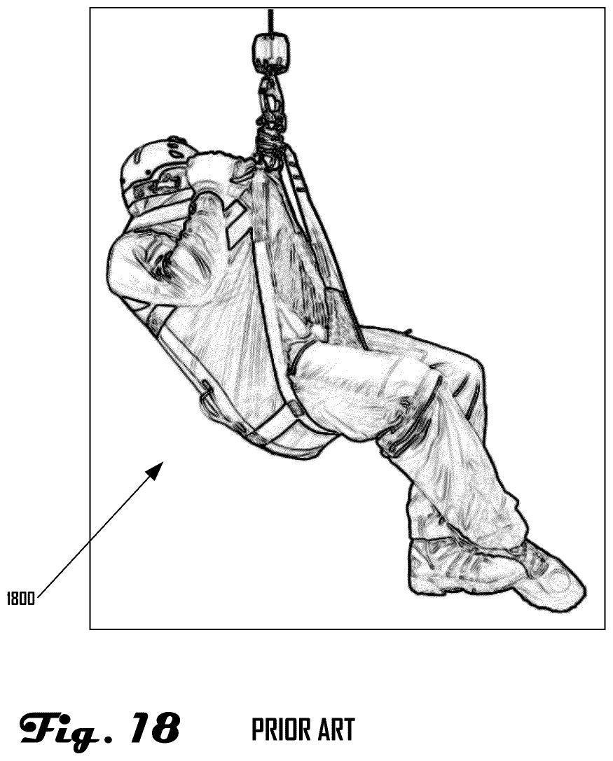

FIG. 3 illustrates human 110 in body pouch 100, prior to or during a partial deployment (the examples in FIG. 1 through FIG. 6 should not be understood as a strict depiction of a rescue, but are staged to illustrate elements disclosed herein). In this view, pocket 305 may contain hip retaining portion 121, side retaining area 122, crotch portion 140, and crotch strap 125. Pocket 140 may be formed from or comprise top flap 306; a bottom portion of pocket may be formed from a dedicated bottom flap 307 and or from a portion of hip retaining portion 121 and or crotch portion 140. Pocket 140 may comprise pocket securement 310. Referring to drawing sheet 16 and FIG. 16A through FIG. 16G, pocket securement 310 may comprise, for example, a clip closure 1605, a snap closure 1610, a zipper closure 1615, a magnetic flap closure 1620, a magnetic flap closure with side 1625, a magnetic flap with neoprene 1630, and a bag with flap and clip 1635. Pocket 305 securely contains hip retaining portion 121, side retaining area 122, crotch portion 140, and crotch strap 125 and allows these components to be rapidly deployed and used during a water-based human airlift operation.

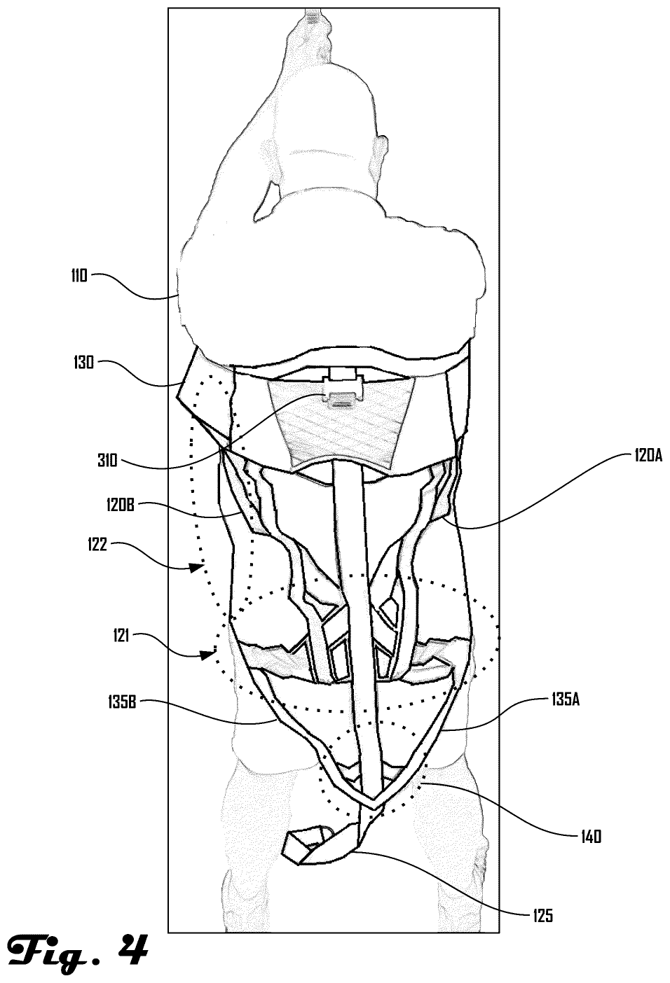

FIG. 4 illustrates human 110 in body pouch 100, further during a partial deployment, compared to a view illustrated in FIG. 3. FIG. 4 illustrates that top connection strap 120A and top connection strap 120B extend from a first side of body pouch 100 to a second side of body pouch 100, crossing one another and crossing a median plane of body pouch 100. FIG. 4 further illustrates hip retaining portion 121 in an approximate location of hips of human 110. FIG. 4 further illustrates that crotch strap 125 extends from and is secured to at least one of crotch portion 140, hip retaining portion 122, and axillary band 130.

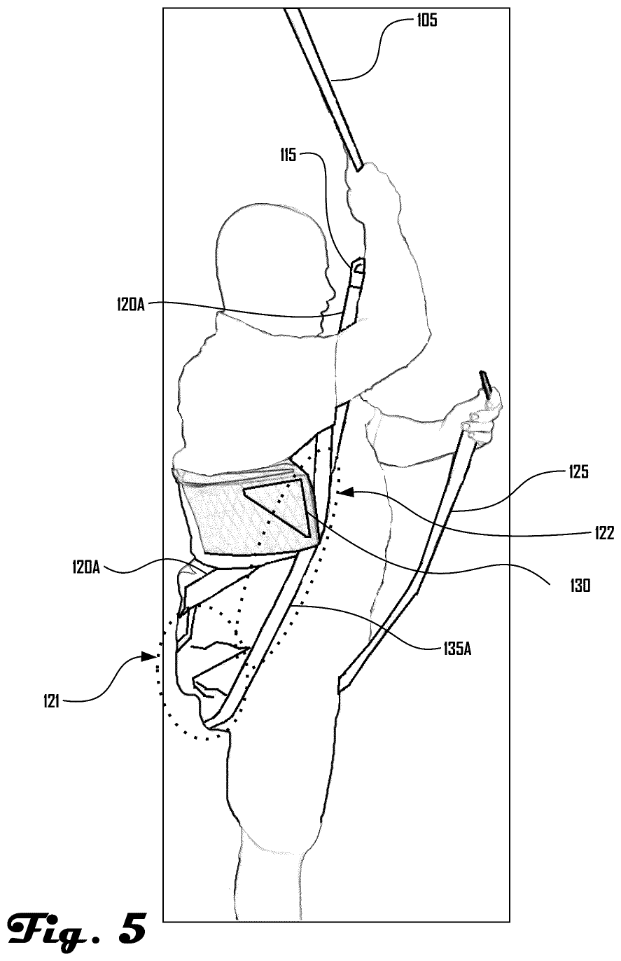

FIG. 5 illustrates human 110 raising crotch strap 125 to suspension cable 105 (again, it should be understood that in rescue operations and water-based human airlift operations, a rescuee does not typically handle the load support in this manner and that FIG. 1 through FIG. 6 are meant to illustrate elements disclosed herein). FIG. 5 illustrates top connection strap 120 extending from connection hardware 115, in the vicinity of suspension cable 105, and passing underneath, through, over and otherwise secured to axillary band 130. FIG. 5 illustrates side retaining portion 122, perimeter webbing 135A, and hip retaining portion 121.

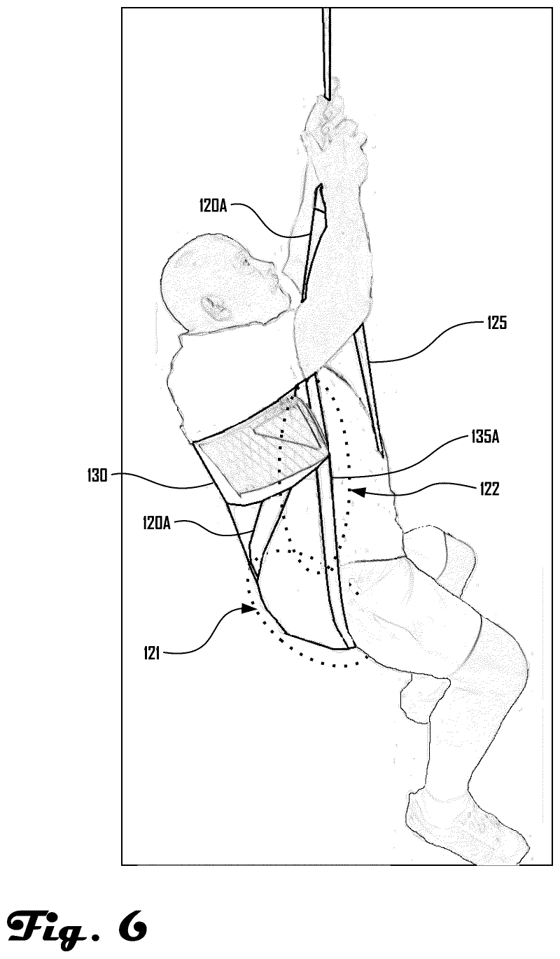

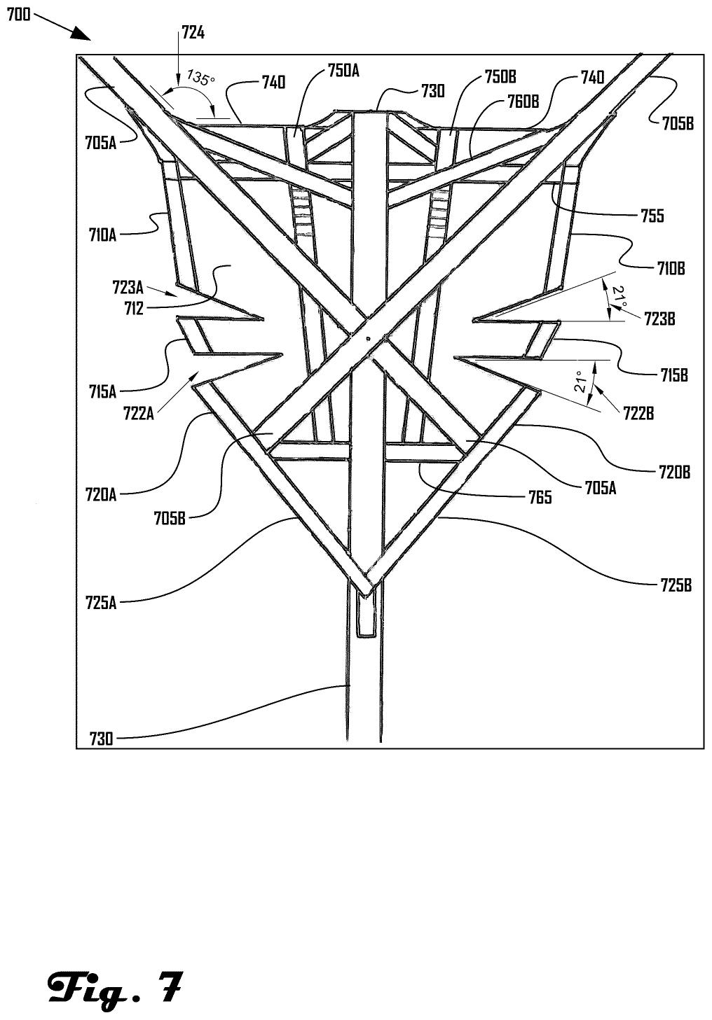

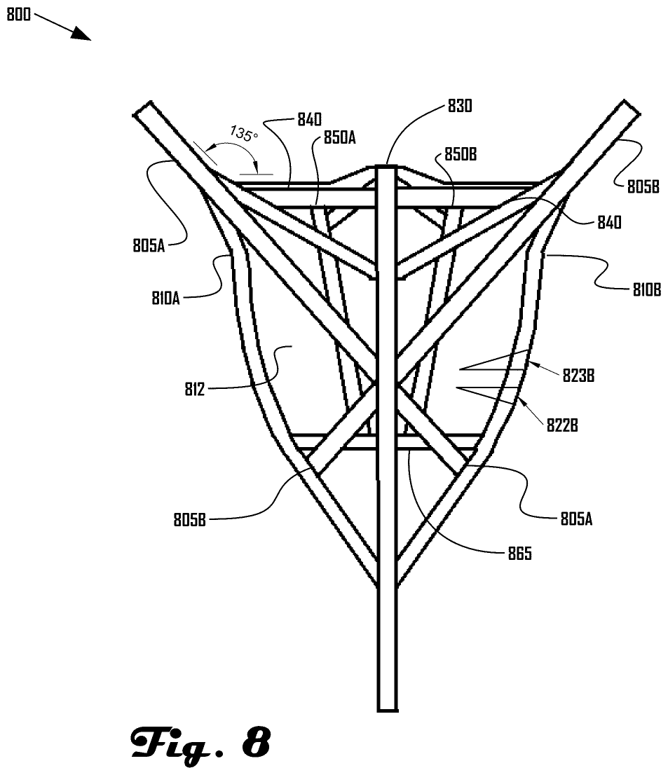

FIG. 6 illustrates human substantially suspended in body pouch 100, with crotch strap 125 secured to top connection strap 120A (and to top connection strap 120B, not visible in FIG. 6) and, firmly secured in body pouch by axial band 130, hip retaining portion 121, and side retaining portion 122. Perimeter band 135A as well as a thigh band (see thigh band 765 and thigh band 865 in FIG. 7 and FIG. 8) may pass below a buttock of human 110 and across a back thigh of human 110 and be distal along the thigh of human 110 relative to a hip socket of human 110.

FIG. 7 illustrates a first example of a pattern, pattern 700, for textiles of a body pouch, according to an embodiment. In the example illustrated in pattern 700, top connection strap 705A and top connection strap 705B cross, pass over, through, and are otherwise secured to axillary band 740. Unlike prior art strops, in which connection straps are parallel to prior art axillary bands, connection strap 705 is secured to axillary band 740 at a 135 degree (or 45 degree) angle 724; a location of this connection may be upper outside corners of axillary band. FIG. 7 illustrates that top connection straps 705 pass across fabric 712, cross one another, and are secured to perimeter band 720A, perimeter band 720B, perimeter band 725A, and perimeter band 725B, at or near thigh band 765. FIG. 7 illustrates dart 722A, 722B, 723A, and 723B. Darts 722 and 723 are cut-outs from, or fold-overs of fabric 712. Darts 722 and 723 contribute to forming a shape of a hip retaining portion, for example, hip retaining portion 121, may be located in the hip retaining portion, and may contribute to a function of hip retaining portion, to hold or cradle a hip or buttock of a human. The hip retaining portion may be understood to comprise a “hip cup”, formed by darts 722 and 723. Only one dart may be used in an embodiment; in other embodiments, more than two darts may be used. Other sewing and fabric handling techniques may be used to contribute to a shape of hip retaining portion. A location where top connection strap 705A and 705B cross one another may be in the hip retaining portion.

FIG. 7 illustrates perimeter band 710, 715, 720, and 725. Perimeter band 710 may be in a side retaining portion, e.g. side retaining portion 122. Perimeter band 715 and 720 may be in a hip retaining portion, e.g. hip retaining portion 121. Perimeter band 725, thigh band 765, and a portion of crotch strap 730 may be in a crotch strap portion, e.g crotch strap portion 140. As illustrated in FIG. 7, the crotch strap portion may be roughly triangular, comprising perimeter band 725A, perimeter band 725B, thigh band 765, and a portion of crotch strap 730.

FIG. 7 illustrates that crotch strap 730 may be secured to at least one of thigh band 765 and or axillary band 740. Forces from a human in the body pouch may be at a maximum on axillary band 740, top connection straps 705, and crotch strap 730, with significant additional forces on perimeter straps 710, 715, 720, and 725. Additional forces and reinforcement may be provided by, for example, middle back band 750, upper back band 760, and the like; these supplemental bands may give a human in the body pouch a feeling of greater security and may distribute forces, such that the human does not feel like as though the human is being “squeezed through” the body pouch.

FIG. 8 illustrates a second example of a pattern, pattern 800, for textiles of a body pouch, according to an embodiment. In the example illustrated in pattern 800, top connection strap 805A and top connection strap 805B cross, pass over, through, and are otherwise secured to axillary band 840. Unlike prior art strops, in which connection straps are parallel to prior art axillary bands, connection strap 805 is secured to axillary band 840 at a 135 degree (or 45 degree) angle 824; a location of this connection may be upper outside corners of axillary band. FIG. 8 illustrates that top connection straps 805 pass across fabric 812, cross one another, and are secured to perimeter band 810A and perimeter band 810B, at or near thigh band 865. FIG. 8 illustrates dart 822 and 823. Darts 822 and 823 may be cut-outs from, or fold-overs of fabric 812. Darts 822 and 823 contribute to forming a shape of a hip retaining portion, for example, hip retaining portion 121, may be located in the hip retaining portion, and may contribute to a function of hip retaining portion, to hold or cradle a hip or buttock of a human. The hip retaining portion may be understood to comprise a “hip cup”, formed by darts 822 and 823. Only one dart may be used in an embodiment; in other embodiments, more than two darts may be used. Other sewing and fabric handling techniques may be used to contribute to a shape of hip retaining portion. A location where top connection strap 805A and 805B cross one another may be in the hip retaining portion.

FIG. 8 illustrates perimeter band 810. A top portion of perimeter band 810 may be in a side retaining portion, e.g. side retaining portion 122. A middle portion of perimeter band 810 may be in a hip retaining portion, e.g. hip retaining portion 121. A bottom portion of perimeter band 810, thigh band 865, and a lower portion of crotch strap 830 may be in a crotch strap portion, e.g crotch strap portion 140. As illustrated in FIG. 8, the crotch strap portion may be roughly triangular, comprising a lower portion of perimeter band 810A, a lower portion of perimeter band 810B, thigh band 865, and a portion of crotch strap 830.

FIG. 8 illustrates that crotch strap 830 may be secured to at least one of thigh band 865 and or axillary band 840. Forces from a human in the body pouch may be at a maximum on axillary band 840, top connection straps 805, and crotch strap 830, with significant additional forces on perimeter strap 810. Additional forces and reinforcement may be provided by, for example, middle back band 850, upper back band 860, and the like; these supplemental bands may give a human in the body pouch a feeling of greater security and may distribute forces, such that the human does not feel like as though the human is being “squeezed through” the body pouch.

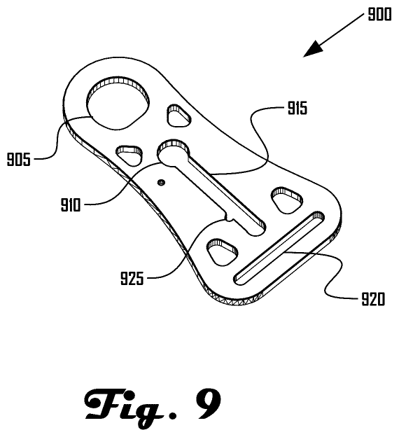

FIG. 9 illustrates connection hardware which may be used to secure one object to another, such as a body pouch to a suspension cable. In the example illustrated in FIG. 9, female connection hardware 900 comprises, for example, the following: carabiner hole 905; receiving area 910 to receive a male connection hardware; slot 915, down which the male connection hardware may pass; recess 925, which may serve as a transient receiving area for a retainer of the male connection hardware; and webbing slot 920, to which webbing may be sewn or otherwise secured.

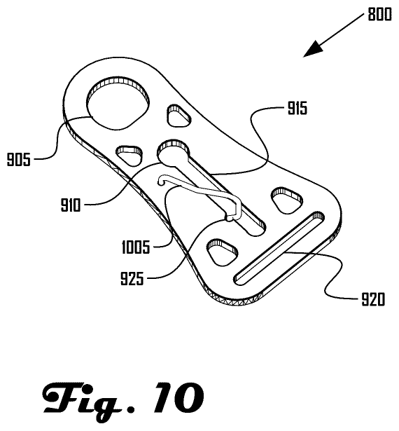

FIG. 10 illustrates female connection hardware 900 further comprising retainer 1005. Retainer 1005 may be a spring. When male connection hardware slides down slot 915, it may displace retainer 1005 into recess 925, following which retainer 1005 may spring back and may then block or act as a barrier against passage of the male connection hardware back up slot.

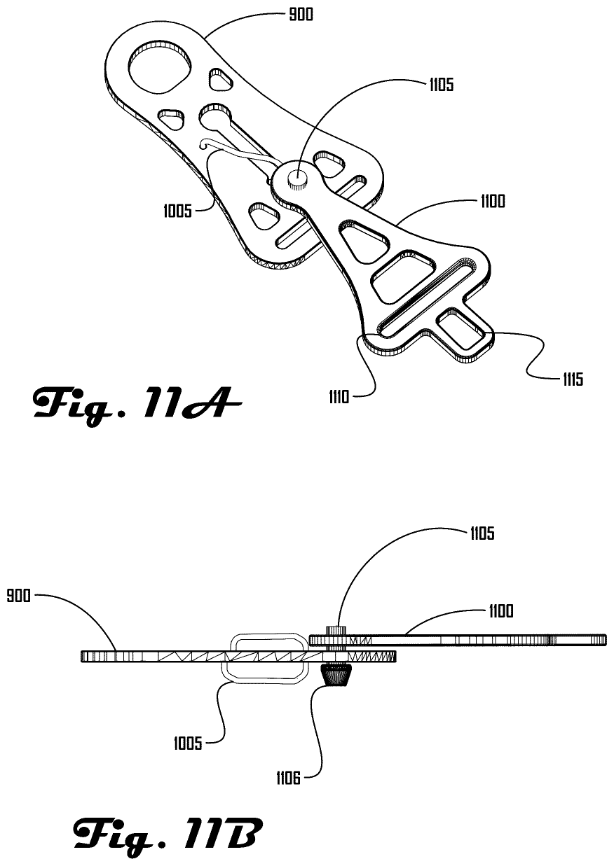

FIG. 11A illustrates female connection hardware 900 and male connection hardware 1100. Male connection hardware 1100 may comprise male projection 1105 and male projection 1106, illustrated in FIG. 11B. Male projection 1106 may pass through receiving area 910, male connection hardware 1100 may then slide down slot 915, and past retainer 1005, such that retainer 1005 prevents male connection hardware 1100 from sliding up slot 915 and from accidentally releasing male connection hardware 1100 from female connection hardware 900. To intentionally release male connection hardware 1100 from female connection hardware 900, a human, such as a rescuer, may actuate retainer 1005, such that retainer 1005 passes into recess 925, whereupon male connection hardware 1100 may pass up slot 915 and male projection 1106 may pass out of receiving area 910.

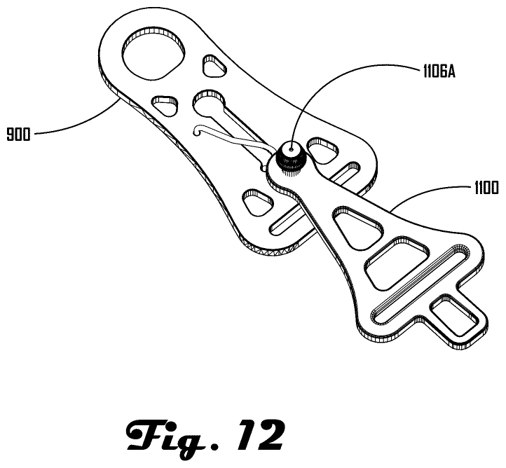

FIG. 12 illustrates that male connection hardware 1100 may be double sided, with two male projections 1106A and 1106B (male projection 1106 in FIG. 11B).

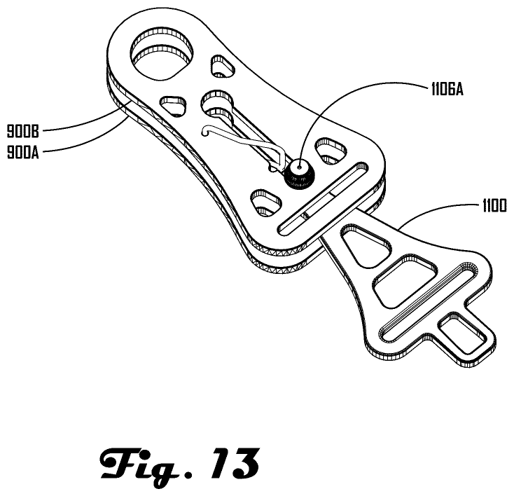

FIG. 13 illustrates that a first female connection hardware 900A and a second female connection hardware 900B may be used with one male connection hardware 1100.

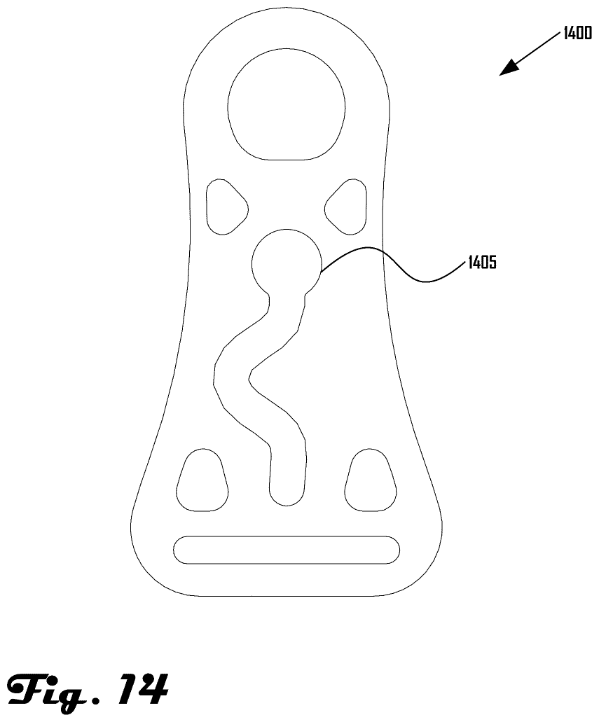

FIG. 14 illustrates an alternative embodiment in which, in place of or in addition to recess 925, slot 1405 follows a serpentine path. The serpentine path may act as a barrier, to reduce a likelihood of male connection hardware unintentionally exiting slot 1405.

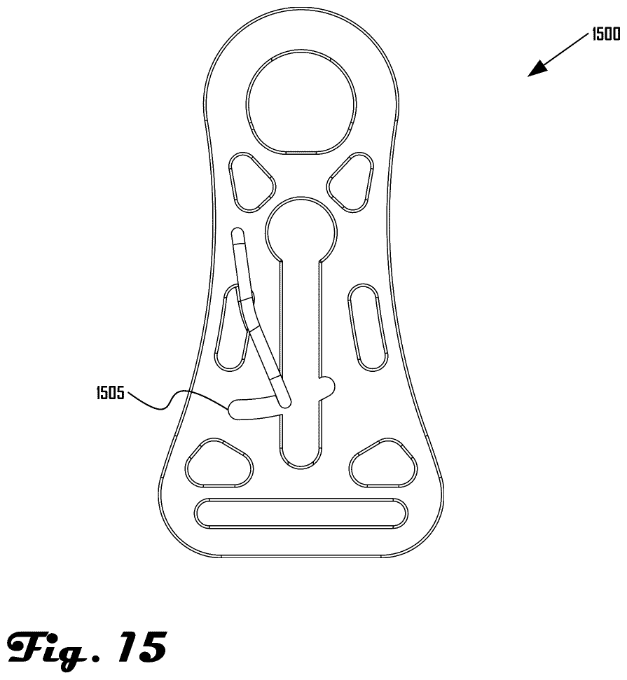

FIG. 15 illustrates an alternative embodiment with a larger recess 1505 (the retainer in FIG. 15 is partially in recess 1505).

Other embodiments of a retainer may be used, including other embodiments which facilitate use of a retainer, including a spring-loaded retainer, when a human, e.g. a rescuer, has limited dexterity or capability, such as due to gloves or the like.

Materials used in the disclosed body pouch, including in fabric, mesh, webbing and the like (materials disclosed as “fabric” or “webbing” may further comprise or be woven or non-woven fabrics, mesh, webbing, may comprise, for example, polyester, nylon, polyester, polypropylene, aramids, vinyl-coated polyester, ultra-high-molecular-weight polyethylene, and composite materials including ultra-high-molecular-weight polyethylene laminated between sheets of polyester and the like may be used. In embodiments, cotton, wool, hemp, rayon, linen and the like may be used. Materials used in connection hardware may include iron, steel, aluminum, titanium, and the like.

Padding may be included, such as in an axillary band. Padding may be provided by, for example, materials such as neoprene, silicone, silicone foam, natural rubber, natural rubber foam, urethane, urethane foam.

References herein to “portion” and the like should be understood as areas; “portions” or the like may be discrete areas or may be regions of a larger structure or structures. Proportions disclosed herein may be varied within the spirit and intention of the disclosure.

Components that are referred to as “secured”, “attached”, “connected” and the like may be sewn, glued, bonded, or otherwise joined together, generally in a permanent manner, unless the context indicates otherwise (e.g. a securement for a pocket may be releasable, including repeatedly releasable and attachable, rather than being a permanent attachment).

The following are example embodiments of a body pouch suitable to airlift a human from water with a carrier:

Example 1. A body pouch suitable to airlift a human from water with a carrier, the body pouch comprising an axillary band, a hip retaining portion, and a crotch portion.

Example 2. The body pouch according to Example 1 or another claim or example herein, wherein the axillary band is to fit around a back, sides, and under armpits of the human and is not to encircle a shoulder of the human.

Example 3. The body pouch according to Example 1 or another claim or example herein, wherein the human is to be suspended below the carrier on a suspension cable.

Example 4. The body pouch according to Example 1 or another claim or example herein, wherein the axillary band is to be secured to a pair of top connection straps.

Example 5. The body pouch according to Example 4 or another claim or example herein, wherein the pair of top connection straps are to cross one another.

Example 6. The body pouch according to Example 5 or another claim or example herein, wherein the pair of top connection straps are to cross one another and terminate in or proximate to the crotch portion.

Example 7. The body pouch according to Example 4 or another claim or example herein, wherein the pair of top connection straps are to span at least from a top corner of the axillary band to a bottom of the hip retaining portion.

Example 8. The body pouch according to Example 4 or another claim or example herein, wherein the pair of top connection straps comprise a first connection strap and a second connection strap and wherein the first connection strap and the second connection strap cross from a first side of the body pouch, across a median plane, to a second side of the body pouch.

Example 9. The body pouch according to Example 4 or another claim or example herein, wherein the pair of top connection straps intersect.

Example 10. The body pouch according to Example 4 or another claim or example herein, wherein the pair of top connection straps are secured to or continuous with the axillary band.

Example 11. The body pouch according to Example 10 or another claim or example herein, wherein the pair of top connection straps are secured to or continuous with upper outside corners of the axillary band.

Example 12. The body pouch according to Example 4 or another claim or example herein, wherein the pair of top connection straps are to intersect with the axillary band at a 45 degree angle.

Example 13. The body pouch according to Example 4 or another claim or example herein, wherein the pair of top connection straps are to be secured to a connection hardware.

Example 14. The body pouch according to Example 1 or another claim or example herein, wherein the hip retaining portion comprises a hip cup.

Example 15. The body pouch according to Example 1 or another claim or example herein, wherein the hip retaining portion is bounded by a thigh band and the crotch portion.

Example 16. The body pouch according to Example 15 or another claim or example herein, wherein the thigh band is to be distal along a thigh of the human relative to a hip socket of the human.

Example 17. The body pouch according to Example 15 or another claim or example herein, wherein the thigh band is to pass below a buttock of the human and across a back thigh of the human.

Example 18. The body pouch according to Example 1 or another claim or example herein, wherein the hip retaining portion comprises at least one dart.

Example 19. The body pouch according to Example 1 or another claim or example herein, wherein the crotch portion comprises a crotch strap and a roughly triangular region of the body pouch.

Example 20. The body pouch according to Example 19 or another claim or example herein, wherein the crotch strap extends at least from the crotch portion to a connection hardware.

Example 21. The body pouch according to Example 19 or another claim or example herein, wherein the crotch strap extends at least from the hip retaining portion to a connection hardware.

Example 22. The body pouch according to Example 19 or another claim or example herein, wherein the crotch strap extends at least from the axillary band to a connection hardware.

Example 23. The body pouch according to Example 1 or another claim or example herein, wherein the crotch portion comprises a thigh band.

Example 24. The body pouch according to Example 23 or another claim or example herein, wherein the thigh band is to be transverse to the crotch strap.

Example 25. The body pouch according to Example 23 or another claim or example herein, wherein the thigh band is to be distal along a thigh of the human relative to a hip socket of the human.

Example 26. The body pouch according to Example 23 or another claim or example herein, wherein the thigh band is to pass below a buttock of the human and across a back thigh of the human.

Example 27. The body pouch according to Example 23 or another claim or example herein, wherein the thigh band is to be secured to a perimeter webbing.

Example 28. The body pouch according to Example 27 or another claim or example herein, wherein the perimeter webbing is to be secured at or proximate to a terminus of the pair of top connection straps.

Example 29. The body pouch according to Example 1 or another claim or example herein, further comprising a side retaining portion.

Example 30. The body pouch according to Example 29 or another claim or example herein, wherein the side retaining portion comprises a perimeter webbing.

Example 31. The body pouch according to Example 30 or another claim or example herein, wherein the perimeter webbing is to span from outside ends of the axillary band to a terminus of the crotch portion.

Example 32. The body pouch according to Example 1 or another claim or example herein, further comprising at least one dart.

Example 33. The body pouch according to Example 32 or another claim or example herein, wherein the at least one dart contributes to a form of the hip retaining portion.

Example 34. The body pouch according to Example 32 or another claim or example herein, wherein the at least one dart is symmetrical on both sides of the body pouch relative to a median plane of the body pouch.

Example 35. The body pouch according to Example 32 or another claim or example herein, wherein the at least one dart comprises a least two darts on one side of a median plane.

Example 36. The body pouch according to Example 35 or another claim or example herein, wherein the at least two darts on one side of the median plane are spaced apart by a spacer portion.

Example 37. The body pouch according to Example 36 or another claim or example herein, wherein the spacer portion is centered on a cross-strap intersection.

Example 38. The body pouch according to Example 32 or another claim or example herein, wherein the hip retaining portion is formed at least in part by the at least one dart.

Example 39. The body pouch according to Example 1 or another claim or example herein, further comprising a weight bearing structure.

Example 40. The body pouch according to Example 39 or another claim or example herein, wherein the weight bearing structure comprises a reinforcement between the axillary band and the hip retaining portion.

Example 41. The body pouch according to Example 39 or another claim or example herein, wherein the weight bearing structure comprises a webbing strap.

Example 42. The body pouch according to Example 39 or another claim or example herein, wherein the weight bearing structure comprises a matrix of webbing straps.

Example 43. The body pouch according to Example 39 or another claim or example herein, wherein the weight bearing structure comprises the pair of top connection straps, the perimeter webbing, and a crotch strap.

Example 44. The body pouch according to Example 1 or another claim or example herein, wherein the axillary band, the hip retaining portion, and the crotch portion form a body retaining structure.

Example 45. The body pouch according to Example 44 or another claim or example herein, wherein the body retaining structure comprises a fabric area, wherein the fabric area is surrounded by a perimeter webbing and is secured to a pair of top connection straps and a crotch strap.

Example 46. The body pouch according to Example 45 or another claim or example herein, wherein the fabric area is further reinforced by a matrix of webbing.

Example 47. The body pouch according to Example 46 or another claim or example herein, wherein the matrix of webbing comprises internal webbing reinforcements.

Example 48. The body pouch according to Example 47 or another claim or example herein, wherein the internal webbing reinforcements are secured to at least a top webbing, a thigh band, a perimeter webbing, and a top connection strap.

Example 49. The body pouch according to Example 1 or another claim or example herein, further comprising a connection hardware.

Example 50. The body pouch according to Example 49 or another claim or example herein, wherein the connection hardware comprises at least one of a carabiner, a clip, a webbing securement, a female connection hardware, and a male connection hardware.

Example 51. The body pouch according to Example 50 or another claim or example herein, wherein the female connection hardware comprises a receiving area for the male connection hardware, and a retainer for the male connection hardware.

Example 52. The body pouch according to Example 51 or another claim or example herein, wherein the retainer for the male connection hardware comprises a spring-loaded retainer.

Example 53. The body pouch according to Example 51 or another claim or example herein, wherein the receiving area for the male connection hardware comprises a slot.

Example 54. The body pouch according to Example 53 or another claim or example herein, wherein the slot comprises a transient receiving area for the retainer for the male connection hardware.

Example 55. The body pouch according to Example 53 or another claim or example herein, wherein the slot comprises an opening sized to receive the male connection hardware.

Example 56. The body pouch according to Example 53 or another claim or example herein, wherein the slot comprises a path into which the male connection hardware is to pass and from which the male connection hardware cannot exit without overcoming a barrier.

Example 57. The body pouch according to Example 56 or another claim or example herein, wherein the barrier comprises one of gravity, a serpentine path, or a spring-loaded retainer.

Example 58. The body pouch according to Example 50 or another claim or example herein, wherein the male connection hardware comprises at least one projection adapted to fit into the female connection hardware.

Example 59. The body pouch according to Example 50 or another claim or example herein, wherein the male connection hardware comprises a first projection and a second projection adapted to fit into the female connection hardware.

Example 60. The body pouch according to Example 50 or another claim or example herein, wherein the female connection hardware is a first female connection hardware, further comprising a second female connection hardware, and wherein the male connection hardware is to fit into the first female connection hardware and the second female connection hardware.

1. A body pouch suitable to airlift a human from water with a carrier, the body pouch comprising an axillary band, a hip retaining portion, and a crotch portion.

2. The body pouch according to claim 1, wherein the axillary band is to fit around a back, sides, and under armpits of the human and is not to encircle a shoulder of the human.

3. The body pouch according to claim 1, wherein the human is to be suspended below the carrier on a suspension cable and wherein the carrier is a helicopter.

4. The body pouch according to claim 1, wherein the axillary band is to be secured to a pair of top connection straps.

5. The body pouch according to claim 4, wherein the pair of top connection straps are to span at least from a top corner of the axillary band to a bottom of the hip retaining portion.

6. The body pouch according to claim 4, wherein the pair of top connection straps comprise a first connection strap and a second connection strap and wherein the first connection strap and the second connection strap cross from a first side of the body pouch, across a median plane, to a second side of the body pouch.

7. The body pouch according to claim 4, wherein the pair of top connection straps are secured to or continuous with the axillary band.

8. The body pouch according to claim 4, wherein the pair of top connection straps are to intersect with the axillary band at a 45 degree angle.

9. The body pouch according to claim 4, wherein the pair of top connection straps are to be secured to a connection hardware.

10. The body pouch according to claim 1, wherein the hip retaining portion comprises a hip cup.

11. The body pouch according to claim 1, wherein the hip retaining portion is bounded by a thigh band and the crotch portion.

12. The body pouch according to claim 11, wherein the thigh band is to be distal along a thigh of the human relative to a hip socket of the human.

13. The body pouch according to claim 11, wherein the thigh band is to pass below a buttock of the human and across a back thigh of the human.

14. The body pouch according to claim 1, wherein the hip retaining portion comprises at least one dart.

15. The body pouch according to claim 1, wherein the crotch portion comprises a crotch strap.

16. The body pouch according to claim 15, wherein the crotch strap extends at least from the crotch portion to a connection hardware.

17. The body pouch according to claim 1, further comprising a connection hardware.

18. The body pouch according to claim 17, wherein the connection hardware comprises at least one of a carabiner, a clip, a webbing securement, a female connection hardware, and a male connection hardware.

19. The body pouch according to claim 18, wherein the female connection hardware comprises a receiving area for the male connection hardware, and a retainer for the male connection hardware.

20. The body pouch according to claim 19, wherein the retainer for the male connection hardware comprises a spring-loaded retainer and wherein the receiving area for the male connection hardware comprises a slot.
